(19) United States
(12) Patent Application Publication
(10) Pub. No.: US 2012/0233065 A1
(43) Pub. Date: Sep. 13, 2012

(54) Automatic Electronic Trip Receipt Recording Method for Chauffeured Vehicles

(75) Inventor: Jason Wu, Taipei City (TW)

(73) Assignee: Shih Pi Ta Technology Ltd

(21) Appl. No.: 13/477,840

(22) Filed: May 22, 2012

Related U.S. Application Data
(62) Division of application No. 12/545,856, filed on Aug. 23, 2009.

(51) Int. Cl. G06Q 50/14; G06Q 40/00

(52) U.S. Cl. 705/39; 705/417

(57) ABSTRACT

An automatic electronic trip receipt recording method for chauffeured vehicles combines an in-car device and a center server to automatically generate an electronic trip reports or receipts for a passenger. The center server includes a dispatch server for transmitting related dispatch data to in-car device, a communication server for wirelessly communicating with the in-car device, a trip data server for storing trip data, and a trip data inquiry server for the passenger to inquire a specified list of trip reports; the in-car device comprises an in-car device main processor for processing signals from modules, which includes a GPS module, a wireless communication module, a boarding/disembarking detecting module, a tachometer counter module, an external meter reading device and a credit/debit card charging and card ID reading device.

### CROSS-REFERENCES

This application is a divisional application of U.S. patent application Ser. No. 12/545,856 filed on Aug. 23, 2009.

### BACKGROUND OF THE INVENTION

1. Field of the Invention

The present invention relates to an automatic electronic trip receipt system and method for chauffeured vehicles, and more particularly, to an automatic electronic trip receipt system which combines an in-car device and a center server to automatically generate an electronic receipt for each trip taken by passengers. In such a system, a passenger can specified a period of time online to retrieve all his trip receipts which include fare, vehicle ID, boarding location and time, disembarking location and time, miles traveled, and other trip related data.

2. Description of the Prior Art

Nowadays, many people take chauffeured vehicles, or taxis, for transportation purposes. These chauffeured vehicles run all over the places for people to conduct business trip, or to visit friends/relatives, see doctors, and do a little sight seeing. For frequently traveling business men, chauffeured vehicles can take them to their destination without worrying about how to find the exact locations and about parking space which is scarce and expensive in a busy city.

On way to take a chauffeured vehicle is to call up the transportation service company; the company takes the passenger data including his current location and dispatches a taxi which is near the passenger to pick up the passenger. For description purpose, we call this kind of passengers as call-a-vehicle passengers. Another way to take a taxi is to hail a taxi on the street; therefore we call this kind of passengers as hail-a-vehicle passengers.

Presently, no matter the passenger hails or calls for a vehicle, the chauffeur start the meter to count the fare when the passenger gets on the vehicle and to charge the passenger with the amount of fare shown on the meter upon arrival. Often the chauffeur needs to provide a receipt to the passenger for his/her patronage.

As to the receipt rendering process, it is inconvenient for the passenger since he/she has to wait for the chauffeur to write the receipt, and the passenger has to take the receipt back to the office to declare the fare. Furthermore, enterprises have to waste a lot of labor and time collecting and auditing these receipts. In many cases, written receipts are sources of mis-reading and expenditure-bill padding. Most important of all, there could be a matter of trust between the company and the passenger. Many organizations or enterprises stop paying tax fares for employees since there are many cases regarding to fake receipts and improper fare declarations in the past. Even though printer may be installed on car to revolve the written receipt problem, the printing device cannot save the collecting and auditing labors, nor can it stop employees from cheating. To counter the expenditure-bill padding problem, some enterprises may choose to use vouchers. But, vouchers create more problems than solve them and generate more cost, because the chauffeurs need to travel back to the transportation company to redeem the voucher for money. In addition, the transportation company needs to have labors processing the vouchers, which in turn produces more cost. As such, vouchers will generally cost more for enterprises or chauffeurs, and it is also a waste of traveling energy. Further, enterprise still needs to waste time and labor to process the vouchers when it comes to pay the vouchers.

Since the prior art techniques cannot provide effective management mechanism to provide convenient processing of the receipt. Therefore, organizations or enterprises have to waste time and labor to process the receipts and verify them. For the case of voucher, it not only wastes time and labor but also costs more for enterprises or organizations.

Furthermore, the above described method/device cannot meet various demands of passengers, which could affect the service quality of chauffeured vehicles. Therefore, the prior art techniques present several shortcomings to be overcome.

In view of the deficiencies of the prior art techniques, after years of constant researches, the inventor has successfully combines communication and electronic component technologies and consequently invented and proposed an automatic electronic trip receipt system and method for chauffeured vehicles in the present invention.

### SUMMARY OF THE INVENTION

The present invention is disclosed to solve the problems described above; therefore, one objective of the present invention is to provide an automatic electronic trip receipt system and method which can provide a better management mechanism to save time, labor and fuel waste for processing paper receipts or vouchers.

Another objective of the present invention is to provide an automatic electronic trip receipt system and method which are convenient and efficient for passengers to use.

The third objective of the present invention is to provide an automatic electronic trip receipt system and method which can automatically accumulate multiple trip data to a passenger's account for chauffeured vehicles.

The main object of the present invention is to provide an automatic electronic trip receipt system and method which combine an in-car device and a center server to automatically generate a electronic trip receipt for each trip taken by passengers; wherein the center server comprises a dispatch server for transmitting related dispatch data, a communication server for wirelessly communicating with the in-car device, a trip data server for recording related data for each trip taken by passengers, and a trip data inquiry server for the passenger to inquire a specific list of trip records; the in-car device comprises an in-car main processor for processing signals from modules, which comprise a GPS module connected with the main processor, the GPS module receiving global positioning signals and transmitting the received global positioning signals to the main processor; a wireless communication module connected with the main processor, the wireless communication module wirelessly communicating with the center server, and transmitting data from the center server to the main processor or transmitting processed data by the main processor to the center server; a boarding/disembarking detecting module connected with the main processor, the boarding/disembarking detecting module detects the transition when passenger boarding or disembarking the vehicle; an tachometer counter module connected with the main processor, the tachometer counter module accumulating the mileage traveled and calculating the fare data; an external meter reading device connected with the main processor, the external meter reading device reading the amount of the fare shown on the external meter; and a credit/debit card charging and card ID reading device connected with the main processor, the credit/debit card charging and card ID reading device charging the passenger or identifying the passenger by reading the card ID.

Since the automatic electronic trip receipt system and method for chauffeured vehicles are convenient for passengers and facilitate better fare management mechanism for enterprises; furthermore, the present invention can accurately identify the passenger and show the real trip data for fare charging, thereby preventing improper fare billing and bill padding. In addition, the present invention will save the time and labor spent in processing paper receipt or voucher by passenger, enterprise, chauffeur, and transportation company.

Although a preferred embodiment of the present invention will be described in detail hereinafter, it should be noted that the preferred embodiment is to be regarded in an illustrative manner rather than a restrictive manner, and all variations and modifications of the basic inventive concepts herein taught still fall within the scope of the present invention

### BRIEF DESCRIPTION OF THE DRAWINGS

FIG. 1 illustrates a device diagram for an automatic electronic trip receipt system for chauffeured vehicles in the present invention;

FIG. 2 illustrates a flowchart of an automatic electronic trip receipt recording method for chauffeured vehicles in the present invention; and

FIG. 3 illustrates a flowchart showing how to register a card ID with the passenger account for passenger identification.

### DETAILED DESCRIPTION OF THE PREFERRED EMBODIMENT

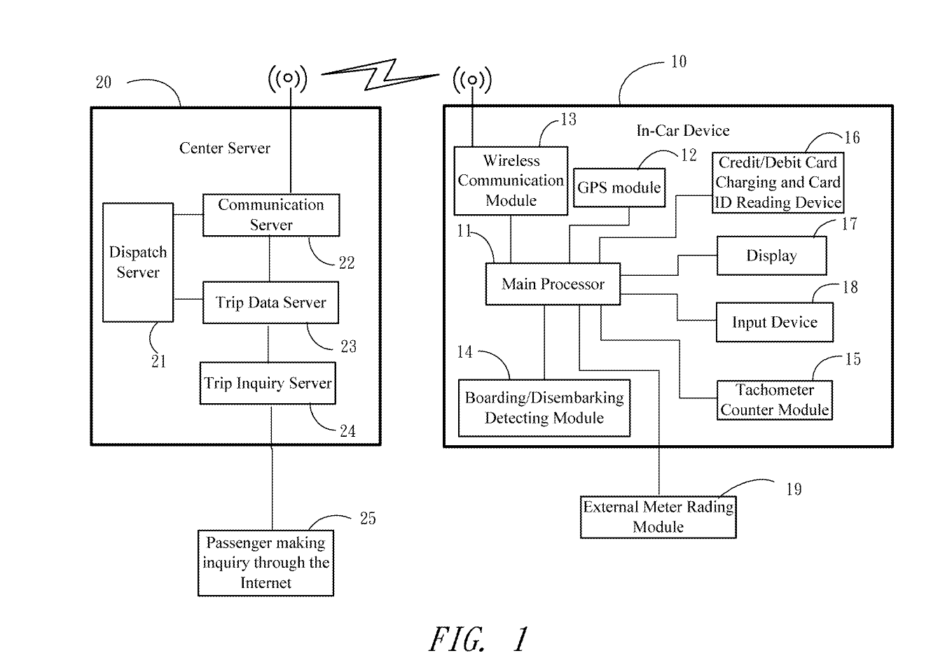

Please refer to FIG. 1 for the system structure of the present invention, from FIG. 1, the system comprises an in-car device 10 and a center server 20, and the center server 20 mainly comprises:

a dispatch server 21 for transmitting and processing related dispatch data;

a communication server 22 wirelessly communicating with the in-car device;

a trip data server 23 for receiving, processing and recording related trip data;

a trip inquiry server 24 for a passenger making inquiry through the Internet 25 to inquire data regarding to a trip fare, vehicle ID, boarding location and time, disembarking location and time, mileage, trajectory, and other trip data;

From FIG. 1, the in-car device 10 mainly comprises:

a main processor 11 for processing signals from modules connected with the main processor and from the center server, the main processor 11 is connected with a global positioning system (GPS) module 12, a wireless communication module 13, a boarding/disembarking detecting module 14, an tachometer counter module 15, a credit/debit card charging and card ID reading device 16, a display 17 and an input device 18;

the GPS module 12 receives GPS signals and connects with the main processor 11; the wireless communication module 13 connects with the main processor 11, the wireless communication module 13 wirelessly communicates with the center server 20 and reads the data of the center server 20 for the main processor 11, or transmits the processed data of the main processor 11 to the center server 20, the wireless communication module 13 can be a general packet radio service (GPRS) module, a 3G module, or a WiMax module; furthermore, the wireless communication module 13 can be equipped with a telephone number for accepting calls from the passenger, and obtains the calling party phone number for identification of the passenger;

the boarding/disembarking detecting module 14 detects the transition event when passenger boarding or disembarking the vehicle;

the tachometer counter module 15 accumulates the mileage traveled and the fare data;

the credit/debit card charging and card ID reading device 16 charges the passenger or identifies the passenger by reading the card ID;

the display 17 shows the trip data;

the input device 18 is provided for inputting text/digit data; and

the external meter reading device 19 reading the amount of the fare shown on the external meter.

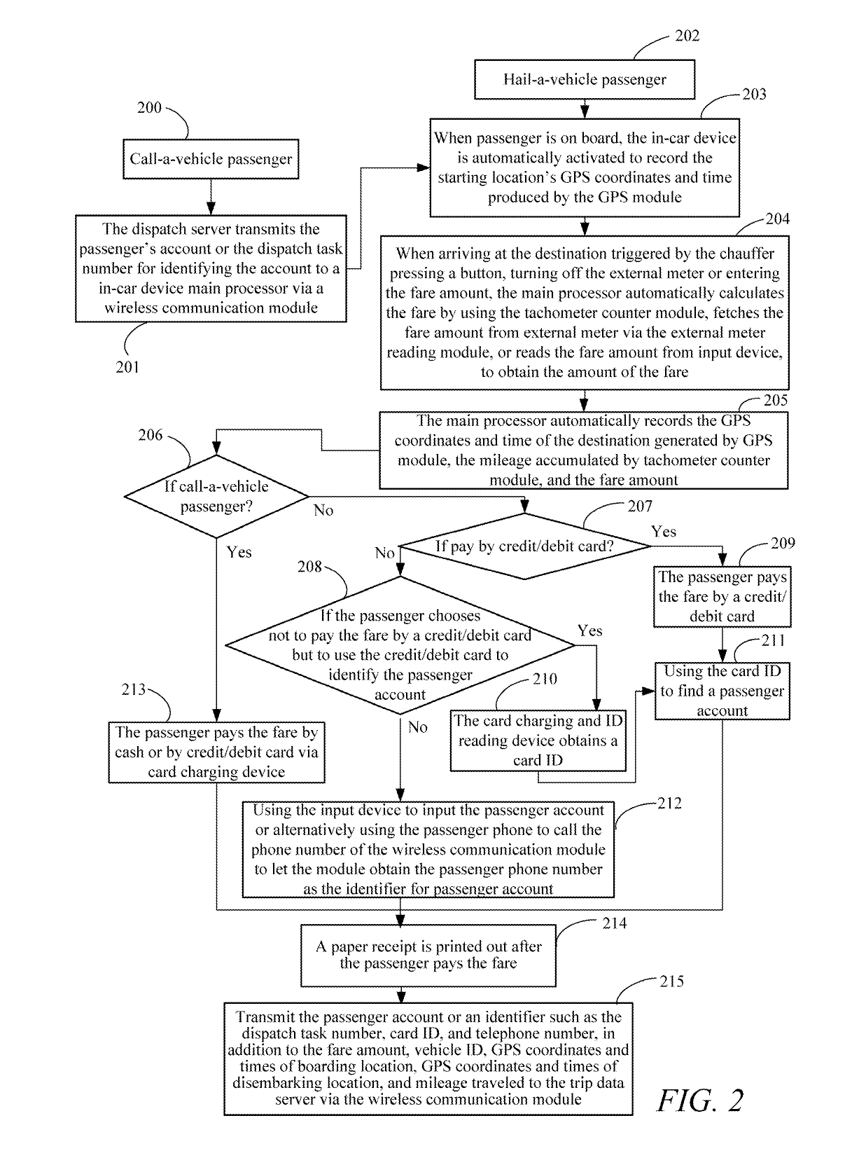

Please refer to FIG. 1 and FIG. 2 for a device diagram for an automatic electronic trip receipt system and a flowchart of the automatic electronic trip receipt recording method for chauffeured vehicles in the present invention. From the figures, when a call-a-vehicle passenger calls the center to get a chauffeured vehicle through a dispatch system (200); the dispatch server 21 transmits the passenger account or the dispatch task number for identifying the account to a in-car device main processor via a wireless communication module 13(201). When the passenger gets on the vehicle or the chauffeur turns the meter on, the in-car device 10 is automatically activated to record a GPS coordinate and a time by the GPS 12 module (203). When arriving at the destination triggered by the chauffer pressing a button, turning off the external meter or entering the fare amount, the main processor 11 automatically calculates the fare by using the tachometer counter module 15, fetches the fare amount from external meter via the external meter reading module 19, or reads the fare amount from the input device 18, to obtain the amount of the fare(204); the main processor automatically records the GPS coordinates and time of the destination location generated by GPS module 12, and the mileage accumulated by tachometer counter module 15, and the fare amount (205). At this time, the main processor has the passenger account number or dispatch task number for identifying passenger account to put together this trip's data including fare amount, boarding/disembarking locations and times, vehicle ID, and mileage, regardless of passenger paying the fare with cash or with credit/debit card (206, 213); a receipt is printed out after the passenger pays the fare (214). Finally, the system can transmit the passenger account or dispatch task number, the fare amount, vehicle ID, the GPS coordinates and times of boarding location, the GPS coordinates and times of disembarking location, and the mileage traveled to the trip data server 23 via the wireless communication module 23 (215), wherein the passenger can connect to the trip inquiry server 24 via internet to inquire a list of trips, gather statistics of the specified list of trips, print the data of the specified list of trips, download the data of the list of trips, or send the electronic receipts or reports of the specified list of trips data to the passenger or a designated recipient e-mail account for further use. Alternatively, when the passenger hails a chauffeured vehicle rather than calls the dispatch center (202) for a vehicle, since the dispatch server cannot automatically transmit the passenger account or customer identification number to the in-car device; it is necessary to use another procedure. When the passenger gets on the vehicle or the chauffeur turns the meter on, the in-car device 10 is automatically activated to record a GPS coordinates and time generated by the GPS 12 module (203) for the pick-up location. When arriving at the destination triggered by the chauffer pressing a button, turning off the external meter or entering the fare amount, the main processor 11 automatically calculates the fare by using the tachometer counter module 15, fetches the fare amount from external meter via the external meter reading module 19, or reads the fare amount from the input device 18, to obtain the amount of the fare(204); the main processor automatically records the GPS coordinates and time of the destination location generated by GPS module 12, the mileage accumulated by tachometer counter module 15, and the fare amount (205), and the fare amount. At this time, if the hail-a-vehicle passenger pays the fare by a credit/debit card (209), then main processor 11 obtain a card ID via the credit/debit card charging and card ID reading device 16 obtains as a passenger ID, which is then sent to the center server 20 to find a passenger account number for putting together all data related to this trip (211). If the hail-a-vehicle passenger chooses not to pay the fare by a credit/debit card but to use the credit/debit card for identifying the passenger account (208), then the credit/debit card charging and card ID reading device obtains a card ID (210) for the main processor as a key to retrieve a passenger account (211) from the center server for putting together all data related to this trip. It should be noted that the conversion of card ID into customer account can be done alternatively in center server when all data related to this trip is sent to the center server instead of being done in the in-car device. In such a case, all data related to this trip is put together with the card ID instead of the customer account number. If the hail-a-vehicle passenger chooses neither to pay the fare by a credit/debit card nor to use the credit/debit card for identifying the passenger account (208), then the input device 18 can be used to input the passenger account (212) for putting together all data for this trip, or alternatively the passenger can call the mobile phone number of the wireless communication module 13 to let the module obtain his private phone number as the identifier for passenger account to hold the data for this trip; After the payment is done, a paper receipt is printed out after the passenger pays the fare (214). Finally, the in-car device transmit the passenger account or the identification number for the account, the amount of the fare, vehicle ID, GPS coordinates and times of boarding location, GPS coordinates and times of disembarking location, and the accumulated mileage to the trip data server 23 via the wireless communication module 13 (215), wherein the passenger can connect to the trip inquiry server 24 via internet to inquire a list of trips, gather statistics of the specified list of trips, print the data of the specified list of trips, download the data of the list of trips, or send the electronic receipts or reports of the specified list of trips data to the passenger or a designated recipient e-mail account for further use.

Regardless of whether it is a call-a-vehicle or hail-a-vehicle passenger and whether the passenger pays the fare with case or credit/debit card, the method described above always has a passenger account number, such as a phone number, or an account identification number, such as dispatch serial number and card ID, to identify the customer account. The passenger account or its identification number is used to put together the amount of the fare, vehicle ID, GPS coordinates and times of boarding location, GPS coordinates and times of disembarking location, and the mileage traveled for the trip. The accumulation of the trip data can be done in the in-car device before being transmitted to center server. Alternatively, data can be transmitted along with an account identification number when it occurs by the in-car device to the center server, and the accumulation of the trip data around a customer account is done in the center server after data are received. As for the customer account number, it is can be a combination of text and digit which can identify the customer uniquely. One example of the customer account number is the customer's telephone number or cell phone number. In addition, the number used in the in-car device as a key to identify the customer account number can be the dispatch task serial number, the card ID obtained via the card reader, and the passenger's private phone number.

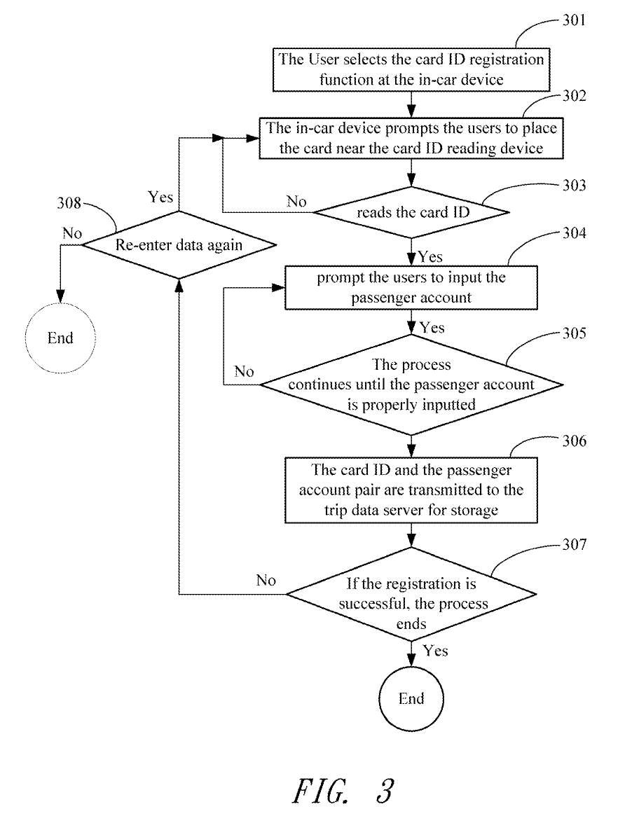

FIG. 3 illustrates a flowchart showing how to register a pair of card ID and passenger account. After the registration, a card ID can be used as a key to retrieve a customer account. When the passenger wishes to register a card ID corresponding to the passenger account, the passenger selects the card ID registration function at the in-car device (301). The in-car device prompts the user to let the card ID reading device read the card ID (302), if it doesn't work, then reads again (303); if it works, then prompt the user to input the passenger account (304); the process continues until the passenger account is properly inputted (305); then the pair of the card ID and the passenger account are transmitted to the trip data server 23 for storage and access (306); if the registration is successful, the process ends (307); if not, then re-enter data again (308). Once the registration is done, the registered card ID will be used as a key to retrieve the passenger account (211).

The in-car device can gather all data of a trip in its memory and upload all the data of the trip to the trip data server 23 only once at the end of the trip. Alternatively, the in-car device can also upload data to the trip data server 23 whenever the data is generated, and the trip data server 23 processes and gathers all the data of a trip after they arrive the trip data server. Still another way, the in-car device can gather all data for multiple trips and transmit them as a batch to the trip data server 23 for process.

The uploaded data can be compiled as a trip report saved at the trip data server 23 for inquiry. The passenger can connect to the trip inquiry server 24 to inquire a report based on time periods such as year/month/day/hour. He can also print out, download or electronically transmit the report to the passenger or a designated recipient e-mail account for further use. The trip inquiry server 24 can generate a report for the passenger or the recipient to check boarding/disembarking locations/addresses on the map and their corresponding times for each trip. The trip inquiry server can also provide the trajectory of the trip with the GPS coordinates sent periodically from the in-car device to the center server.

The present invention relates to an automatic electronic trip receipt system and method for chauffeured vehicles, while compared to other prior art techniques, is advantageous in:
1. The present invention provides a easy-to-use charging system and method which can accumulate data of multiple trips to each individual customer account.
2. The present invention is convenient for passengers in taking chauffeured vehicles without wasting time waiting for paper receipt or voucher process.
3. The present invention provides enterprises with better receipts management mechanism to save time and labor for processing and verifying paper receipt or voucher.
4. The present invention facilitates an trust-worthy party to automatically provide audited electronic trip data for both passenger and enterprise through e-mail; this reduce the need for the enterprise to process and verifying paper receipt or voucher.
5. The present invention help chauffeur and transportation service company to save time, fuel, and labor processing vouchers.
6. The present invention can automatically gather all trip data for each passenger electronically, and each passenger can select to obtain these the electronic data for further processing.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic electronic trip receipt recording method for chauffeured vehicles comprising the following steps:
i. a call-a-vehicle passenger calling a dispatch center to get a chauffeured vehicle through a dispatch system;
ii. a dispatch server transmitting the passenger's account or the dispatch task number for identifying the account to a in-car device main processor via a wireless communication module;
iii. when the call-a-vehicle passenger gets on the vehicle or the chauffeur turns the meter on, a main processor being automatically activated to record the GPS coordinates and a time generated by a global positioning system (GPS) module as the boarding location data;
iv. when arriving at the destination triggered by the chauffer pressing a button, turning off the external meter or entering the fare amount, the main processor automatically calculating the fare by using the tachometer counter module, fetching the fare amount from external meter via the external meter reading module, or reading the fare amount from the input device, to obtain the amount of the fare;
v. the main processor automatically recording the GPS coordinates and time of the destination location generated by GPS module, the mileage accumulated by tachometer counter module, and the fare amount;
vi. the main processor has the passenger account number or dispatch task number for identifying passenger account to put together this trip's data including fare amount, boarding/disembarking locations and times, vehicle ID, and mileage, regardless of passenger paying the fare with cash or with credit/debit card;
vii. in-car printer printing out a paper receipt for this trip after the passenger pays the fare; and
viii. the main processor transmitting the passenger account or the dispatch task number, the fare amount, vehicle ID, GPS coordinates and times of boarding location, GPS coordinates and times of disembarking locations, and mileage traveled to a trip data server via a wireless communication module, wherein the passenger can connect to the trip inquiry server 24 via internet to inquire a list of trips, gather statistics of the specified list of trips, print the data of the specified list of trips, download the data of the list of trips, or send the electronic receipts or reports of the specified list of trips data to the passenger or designated recipients' e-mail account for further use.

2. The automatic electronic trip receipt recording method for chauffeured vehicles as claimed in claim 1, wherein the passenger account can be a private phone number of the passenger or a combination of text and digit to identify different passengers.

3. The automatic electronic trip receipt recording method for chauffeured vehicles as claimed in claim 1, wherein the dispatch server transmits the passenger account or the dispatch task number to the main processor via the wireless communication module on the chauffeured vehicle as identifier for passenger account.

4. The automatic electronic trip receipt recording method for chauffeured vehicles as claimed in claim 1, wherein the dispatched passenger inputs the passenger account by using the input device on the chauffeured vehicle; the input device can be a keyboard.

5. The automatic electronic trip receipt recording method for chauffeured vehicles as claimed in claim 1, wherein the passenger calls up the phone number of the wireless communication module on the chauffeured vehicle to let the wireless communication module automatically obtain the phone number as a identifier for passenger account.

6. The automatic electronic trip receipt recording method for chauffeured vehicles as claimed in claim 1, wherein the passenger pays the fare by cash but uses the credit/debit card charging and card ID reading device to read the passenger's card ID as identifier for the passenger account.

7. The automatic electronic trip receipt recording method for chauffeured vehicles as claimed in claim 1, wherein the dispatched passenger pays the fare by credit/debit card and let the credit/debit card charging and card ID reading device obtain the passenger's card ID as identifier for the passenger account.

8. The automatic electronic trip receipt recording method for chauffeured vehicles as claimed in claim 1, wherein the in-car main processor accumulates all data for one trip together in the memory and send it as a whole to the trip data server.

9. The automatic electronic trip receipt recording method for chauffeured vehicles as claimed in claim 1, wherein the in-car main processor sends each data immediate to the trip data server soon as each data is generated, and the trip data server assemble multiple data related to one trip together for later use when it receive these separately sent data.

10. The automatic electronic trip receipt recording method for chauffeured vehicles as claimed in claim 1, wherein the passenger or his/her company can inquire the boarding and/or disembarking locations and their corresponding times with text description such as address or direction or on a map.

11. The automatic electronic trip receipt recording method for chauffeured vehicles as claimed in claim 1, wherein the in-car device send the GPS coordinate and its time periodically to the center server during the trip for a historical record of trip trajectory.

12. The automatic electronic trip receipt recording method for chauffeured vehicles as claimed in claim 1, wherein the dispatched passenger can specify a trip to check its fare, boarding location and time, disembarking location and time, and mileage as well as the trip's trajectory.

13. The automatic electronic trip receipt recording method for chauffeured vehicles as claimed in claim 1 further comprising a mobile payment method in which the in-car device transmitting mobile phone number and the payment amount to the center server, then the center server communicates with the customer's mobile phone to deduct the payment amount and uses the mobile phone number as identifier for passenger's account.
